(19) United States
(12) Patent Application Publication
(10) Pub. No.: US 2004/0035276 A1
(43) Pub. Date: Feb. 26, 2004

(54) Device for cutting up food products, comprising two cutter heads

(76) Inventor: Gunther Weber, Zachow (DE)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/415,627

(22) PCT Filed: Nov. 2, 2001
(86) PCT No.: PCT/EP01/12724

(30) Foreign Application Priority Data
Nov. 3, 2000 (DE) 100 54 514.9

(51) Int. Cl. B26D 1/12

(52) U.S. Cl. 83/672; 83/932

(57) ABSTRACT

The invention relates to a device for cutting up food products (4), in the form of a slicer. Said device is equipped with at least two cutter heads (9,10). The product flows produced by each cutter head are either combined and processed in the form of one product flow or are processed in the form of a plurality of product flows.

The invention relates to an apparatus for the slicing of food products, in particular ham, sausage, cheese and the like, having a product supply system and a cutting station as well as conveying means disposed down-stream of the cutting station for the transporting away of the sliced products.

Apparatuses of this kind, which are also termed slicers, are known. Slicers are also already in practical use which have two product supply units which extend parallel to one another for the purpose of increasing the cutting performance such that two products can be sliced simultaneously with the cutting knives circulating in a planetary manner and driven in a rotating manner.

All currently known slicers have only one single cutter head and have intermittent or continuous supply feeds. Intermittent supply feeds are as a rule used for short products such as raw ham or a block of cheese, whereas the continuous supply feeds are used for long product strings such as sausage or boiled ham.

Intermittent supply feeds above all have the disadvantage of time loss and the interruption of the product flow caused by this resulting from the respective very high loading time in relation to the cutting time.

Continuous supply feeds have the disadvantage that the products are no longer sufficiently guided or held toward the end of the cutting process and losses thereby occur due to the transition region between the products. Moreover, it generally applies to slicers having only one cutter head that the maximum product width to be cut is restricted in dependence on the respectively used single cutter head.

Furthermore, it is disadvantageous in the known apparatuses of this kind that it is not possible, or is only possible with a very high technical conveying effort, to achieve a continuous product flow in connection with the successive slicing of the individual products such as is required for packaging machines operating without interruption.

It is the object of the invention to decisively increase the capacity in an apparatus of the kind first named with at least approximately the same personnel effort and to make possible an optimum utilization of succeeding systems.

This is above all achieved by the invention in that the apparatus is equipped with at least two cutter heads and the product flows produced per cutter head are either guided together to form a preferably continuous product flow and are further processed or are further processed in the form of a plurality of product flows.

The advantages of the apparatus in accordance with the invention, in which the product supply unit, or the product supply units, as well as the cutter heads respectively associated with them and having associated drives are integrated in a common base construction, can be represented as follows with respect to their operation:

The following advantageous aspects result with a simultaneous output of at least two product flows, in particular in the use for long products which are supplied e.g. continuously, or in which the product change-over time plays a more subordinate role in relation to the cutting time due to the large product length:

Due to the use of at least two cutter heads per apparatus, at least a doubling of the maximum cutting width, and thus a doubling of the cutting performance, is created. This results in particular in the fact that, on the cutting of portions with a low number of slices, the capacity of the existing downstream systems, e.g. the packaging machines, can be utilized to the full, which was previously frequently not achievable.

The following applies to the case of an operation of the apparatus in which the product flows are output alternately, i.e. not parallel, in particular in the use for short products in which, due to the low product length, the product change-over time represents a substantial disadvantage in relation to the cutting time for the continuity of the succeeding processes, and thus of the total performance of the system: Due to this alternate operation, or to the alternate output of the product flows, the irritating product change-over time does not come into effect, since, during the cutting time of the one cutter head, the supply feed of another cutter head can be loaded.

This in turn has the consequence that intermediate storage procedures in the conveying systems disposed downstream can be omitted, on the one hand, and the unwanted stopping of packaging machines, which was previously only possible with a large technical conveying effort, is no longer required, on the other hand.

During the good cutting phase of a product located in a product supply unit, not only a feed procedure can be carried out in another product supply feed, but also an initial cutting procedure with a simultaneous guiding away of chips and not yet usable slices. This has the consequence that, at a suitable point in time at which the end region of the product to be sliced no longer usable with respect to the required slices is reached in the one supply unit, the product feed can be stopped, and in the other product supply unit the product feed can be started such that now this unit newly taken into operation delivers slices of the same kind.

By a technical conveying guiding together of the slice flows originating from the two units, the required uninterrupted flow of good slices, i.e. a flow of slices with the required thickness and size, is obtained.

It is particularly interesting that this operation can also be realized when products of small length, e.g. products which are shorter than approximately 80 cm, have to be sliced.

An individual operation of the individual supply units as well as of the cutter heads associated with them and having different knife revolution speeds makes it possible to slice different products with different numbers of slices simultaneously per time unit and thus in turn to produce so-called mixed packs in a particularly economic manner in connection with the corresponding conveying technique.

Within the framework of the invention, it is of substantial importance that the overall performance of the apparatus can be considerably increased with approximately the same personnel effort and the capacity of existing succeeding systems can be utilized better.

Further advantageous embodiments of the invention are recited in the dependent claims.

An embodiment of the invention will be explained in the following by way of example with reference to the drawing, in which are shown:

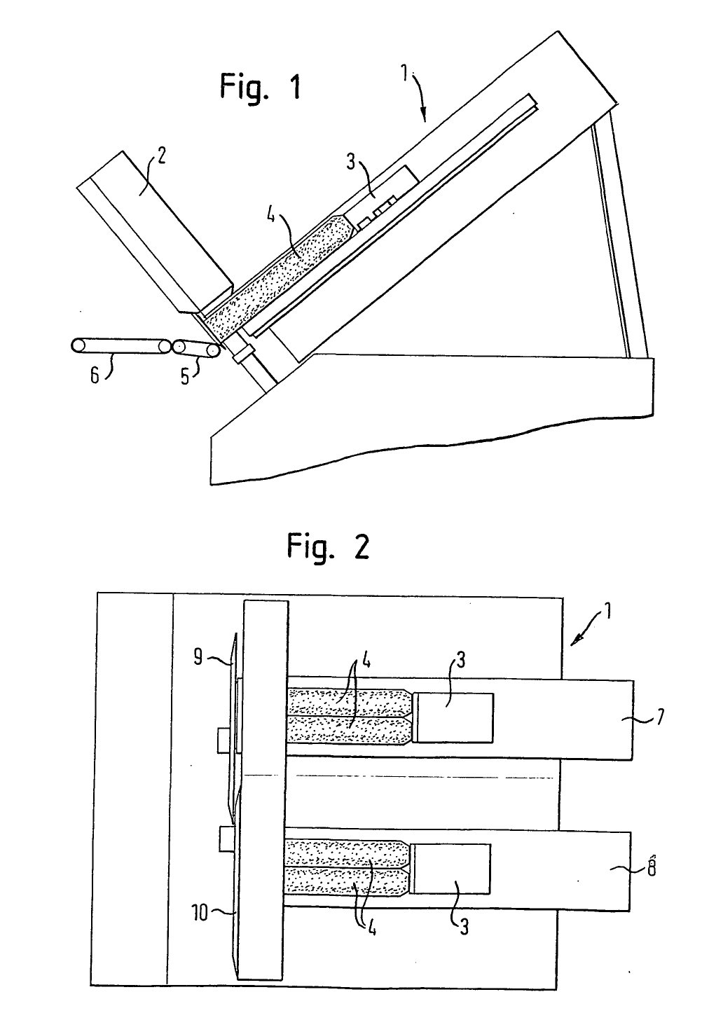

FIG. 1 a schematic side view of a slicer in accordance with the invention;

FIG. 2 a plan view of the slicer in accordance with FIG. 1;

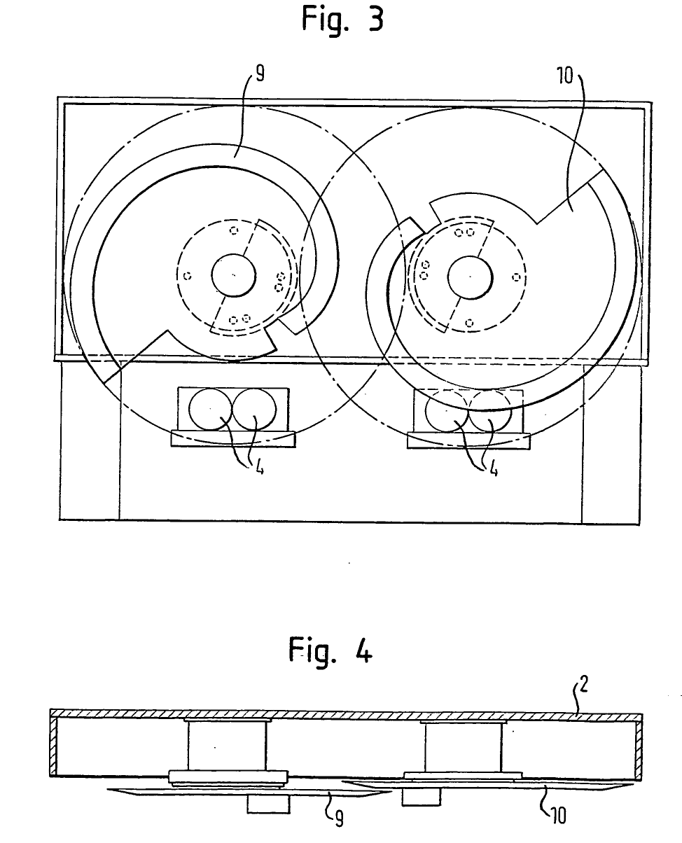

FIG. 3 a front view of the dual cutter head of the slicer in accordance with FIGS. 1 and 2; and

FIG. 4 a schematic plan view of the dual cutter head in accordance with FIG. 3.

FIG. 1 shows the basic components of a slicer formed in accordance with the invention in a side view, with the product supply feed 1, which extends obliquely to the horizontal, and the cutter head housing 2, which is provided at the end of the product supply feed 1, being able to be seen. The product supply feed 1 includes one or more product holders 3 for products 4 to be sliced. A first conveyor 5, which is formed in a relatively short manner, is provided to receive the slices formed during the cutting process and has a belt 6 for transporting away disposed downstream of it. Further conveyor elements and conveyor units which are used for the separate guiding away of individual slice flows or for the guiding together of a plurality of slicer flows are not shown in the drawing. Such conveyor means are known.

The conveyor unit 5 intended for the direct reception of the cut slices can be operated in the forward direction and in the reverse direction so that chips arising in particular in starting cut procedures or non-usable slices can be guided away in reverse operation.

An individually controllable conveyor 5 is preferably provided for each cutter head and can also be made lowerable for the forming of stacks.

Like all apparatuses formed in accordance with the invention, the embodiment shown in the drawings is equipped with at least two cutter heads, which can be seen individually in FIG. 2. Each cutter head includes a knife 9 or 10 respectively, with this knife being able to be designed as a sickle knife or as a round knife circulating in a planetary manner.

At least the cutting knives are preferably arranged in an axially offset manner and they can be driven by a common drive or independently of one another. The supply feed of the products 4 to be sliced to the respective cutter heads can take place by means of a product supply unit 1 common to the cutter heads, i.e. the product holders 3 are driven by a common motor and are actuated together with respect to the forward feed movements and backward stroke movements. In this case, at least two product flows are output at the same time and this variant is in particular suitable for long products in which the product change-over time is very small with respect to the cutting time.

Above all on the slicing of short products, in which the product change-over time is relatively large with respect to the cutting time due to the low product length, each cutting unit has its own product supply unit 7, 8 associated with it. In this case, the product supply units can be controlled individually and the product flows are output alternately. Since, during the cutting time of one cutter head, the supply feed of another cutter head is loaded, it is possible in this manner to avoid any irritatingly long product change-over time. It is rather possible to add the product flows arising in alternate operation to one another without interruption.

The front view in accordance with FIG. 3 shows two cutter heads arranged next to one another in the same apparatus and having sickle knives 9, 10. The products 4 supplied to the respective cutting knives lie within the respective circumferential cutting circles and it can also be seen that the cutting knives of the two cutter heads run at offset angles to one another in their orbits. Furthermore, the cutting knives 9, 10 as can in particular be seen in FIG. 4—are arranged offset to one another in the axial direction.

Even though only two cutter heads are shown in connection with the embodiment, it is understood that a larger number of cutter heads can also be used within the framework of the invention and these—just like the two cutter heads in accordance with the embodiment shown—are integrated into a common base construction including the product supply unit, or the product supply units, associated with them and all associated drives.

1. An apparatus for the slicing of food products, in particular ham, sausage, cheese and the like, having a product supply system and a cutting station as well as conveyor means disposed downstream of the cutting station for the transporting away of the sliced products, characterized
in that the apparatus is equipped with at least two cutter heads which are integrated in a common base construction and whose knives are designed as sickle knives or as round knives driven in a rotating manner and circulating in a planetary manner and cooperate with a respective separate cutting edge;
in that the product supply system includes a product supply unit for at least two products being supplied in parallel or at least two product supply units which are arranged adjacent to one another and which can in particular be individually controlled; and
in that the product flows produced in parallel per cutter head are led together to form one product flow by means of individual conveyors (5, 6) and are further processed or are further processed in the form of a plurality of product flows.

2. An apparatus in accordance with claim 1, characterized in that the product supply units can be controlled individually or jointly with respect to their feed movements and their retraction movements.

3. An apparatus in accordance with claim 1 or claim 2, characterized in that the product supply units are arranged obliquely to the horizontal at least in operation and can preferably be pivoted individually into a loading position.

4. An apparatus in accordance with any one of the preceding claims, characterized in that the cutter heads associated with the individual product supply units are driven by a common drive.

5. An apparatus in accordance with any of claims 1 to 3, characterized in that the cutter heads associated with the individual product supply units each have their own drive.

6. An apparatus in accordance with any one of the preceding claims, characterized in that the speeds of revolution of the drives, and thus the cuts carried out by the respective knife per unit of time, can be set differently and thus portions of different numbers of slices can be produced.

7. An apparatus in accordance with any one of the preceding claims, characterized in that the cutting plane of the individual cutter heads defined by the plane of circulation of the knives, and thus the respectively associated cutting edges, are offset to one another in the product supply direction or in the axial direction.

8. An apparatus in accordance with any one of the preceding claims, characterized in that the cutting knives of the individual cutter heads run angularly offset to one another in their orbits.

9. An apparatus in accordance with any one of the preceding claims, characterized in that the product supply unit, or the product supply units, as well as the cutter heads respectively associated with them and having associated drives, are integrated in a common base construction.
